(19) United States
(12) Patent Application Publication
(10) Pub. No.: US 2003/0147243 A1
(43) Pub. Date: Aug. 7, 2003

(54) Lamp and hood assembly forming an illuminating light sculpture

(76) Inventor: Yuval Alduby, Tel Aviv (IL)

Correspondence Address: BIRCH STEWART KOLASCH & BIRCH, PO BOX 747, FALLS CHURCH, VA, 22040-0747, US

(21) Appl. No.: 10/061,225

(22) Filed: Feb. 4, 2002

(51) Int. Cl. F21V 5/02; F21V 29/00

(52) U.S. Cl. 362/311; 362/340; 362/334; 362/355; 362/294

(57) ABSTRACT

A lamp and hood assembly adapted to create an illuminating light sculpture functioning as a source of illumination as will as a work of abstract or figurative art. The hood of the assembly is molded of translucent elastomeric material to assume the desired form of sculpture which has a cavity therein to accommodate the envelope of an electric lamp enclosing the light generating components to which power is supplied. When the lamp is turned on, the sculpture is then internally illuminated, rays passing through the translucent hood being diffused thereby to illuminate an external region with “soft” rays. The different thicknesses of the hood material produced by indentations and depression which express the artistic form of the hood result in corresponding differences in the intensity of light radiated from the hood to create a pattern of light that defines the sculpture.

### BACKGROUND OF THE INVENTION

1. Field of the Invention

This invention relates generally to shades for diffusing light radiated from an electric lamp to produce “soft” illumination. More particularly, this invention relates to a lamp and hood assembly forming an illuminating light sculpture which functions as a source of “soft” illumination as well as a work of abstract or figurative sculpture.

2. Status of Prior Art

A standard lamp of the incandescent light bulb type includes a bulbous glass envelope anchored on a cylindrical base threaded to form a plug that can be screwed into a socket supplying power to the bulb. In a compact fluorescent tube lamp, the envelope is an elongated glass tube sinuously curved to form a cluster of two or more hoops anchored on a base connectable to a power source.

The present invention in which a hood fits over an electric lamp is applicable to any type of lamp (incandescent fluorescent or otherwise) having a “concentrated” envelope anchored on a base provided with a connector of some sort that is connectable to a power outlet. The connector can be in the form of a screw plug, as in a conventional incandescent bulb or it can be of the bayonet or contact pin type.

By concentrated lamp envelope is means a lamp envelope enclosing the light generating components that is confined to a region directly above the base of the lamp. Thus the concentrated envelope of a standard incandescent lamp is a glass bulb anchored on a base. In a compact fluorescent lamp, the concentrated envelope is curved to form a cluster of hoops which are supported above the base of the lamp.

Standard electric lamps of the incandescent and compact fluorescent types generate light whose intensity depends on the wattage rating of the lamp. But in all vases, a standard lamp, when naked and unshaded, yields a harsh light which though suitable for industrial uses is not acceptable for domestic applications which prefer that the light illuminating an interior be “soft”. That is to say, the light must not be bright or glaring so that its illumination does not irritate the eyes of individuals exposed thereto.

It is therefore common practice to provide an electric lamp with a shade which acts to scatter and diffuse and thereby soften light radiating from the lamp. In shades formed of woven fabric material, the light rays pass through the fine interstices of the fabric and are dispersed thereby. In shades or lamp housings formed of ground glass or plastic translucent panels, these act to diffuse the light to avoid excessive glare or brightness.

Naked electric lamps have an appearance which is strictly utilitarian. However, these lamps can be rendered attractive by means of decorative shades which conceal the lamp being shaded. In order to mount a shade on a lamp, a fixture of some sort is required that is appropriate to the lamp structure and also to that of the shade. A lamp shade must surround and be spaced from the lamp it shades. This restricts the geometry of the shade to symmetrical shapes, and in doing so limits the artistic or decorative possibilities of the shade configuration.

To render a lamp more attractive it is known to combine the lamp with a work of sculpture. In a typical lamp of this type, the stand for the lap, instead of being a pole or rod, is an upright work of figurative sculpture such as that of a so female figure whose band is outstretched to hold the socket for the lamp on which a shade is mounted. In this arrangement, the sculpture is externally illuminated by light from the lamp. Existing arrangements in which a tamp is combined with a work of sculpture are relatively costly. Moreover, since the sculpture is externally illuminated by a shaded lamp and is below this lamp, it may not be clearly visible.

### SUMMARY OF THE INVENTION

In view of the foregoing, the main object of this invention is to provide a lamp and hood assembly forming an illuminating light sculpture which functions as a source of illumination as well as a work of abstract or figurative sculpture.

By light sculpture is meant a work of sculpture whose form is defined by light and therefore glows.

More particularly, an object of this invention is to provide an assembly of the above type in which the work of sculpture is a translucent hood that is internally illuminated, the rays from the lamp passing through the translucent hood being diffused thereby to illuminate an external, region with “soft” light.

Among the significant advantages of an assembly in accordance with the invention are the following:

1. The shade for the lamp is created by a translucent hood that fits directly onto the lamp; hence no fixture is required to mount a shade thereon.

2. The hood which is molded of elastomeric material can readily be fitted onto the lamp to shade the lamp, and can easily be pulled off the lamp so that it can be replaced by another sculptured hood having a different design.

3. The hood formed of elastomeric material acts as a safety blanket to protect the lamp from injury, without however significantly reducing the light available for illumination.

4. The decorative hood conceals the lamp and suppresses its utilitarian appearance.

Also an object of this invention is to provide a hood that can be injection or otherwise molded at relatively low cost regardless of its sculptural complexity.

Briefly stated these objects are attained in a lamp and hood assembly adapted to create an illuminating light sculpture functioning as a source of illumination as well as a work of abstract or figurative art. The hood of the assembly is molded of translucent, elastomeric material to assume a desired form of sculpture having a cavity therein to accommodate the glass envelope of an electric lamp to which power is supplied. When the lamp is tuned on, the sculpture is then internally illuminated, rays passing through the translucent hood being diffused thereby to illuminate an external region with “soft” rays.

The different thicknesses of the hood material produced by indentations and depressions which express the artistic form of the hood result in corresponding differences in the intensity of light radiated from the hood to create a pattern of light that defines the sculpture.

### BRIEF DESCRIPTION OF THE DRAWINGS

For a better understanding of the invention and as well as other objects and features thereof, reference is made to the annexed drawing wherein:

FIG. 1 illustrates a first embodiment of a lamp and hood assembly in accordance with the invention in which the lamp is an incandescent light bulb; the lamp and the hood being cut away to expose the interior cavity of the hood;

FIG. 2 is a perspective view of the hood included in the first embodiment.

FIG. 3 is a partially schematic perspective view of the second embodiment of an incandescent lamp and hood assembly in accordance with the invention;

FIG. 4 is a sectional view taken in the transverse plane indicated by line 4-4 in FIG. 3;

FIG. 5 is a cut away view of the second embodiment of the lamp and hood assembly, the lamp being of the compact fluorescent tube type;

FIG. 6 shows the interior of the hood included in FIG. 5;

FIG. 7 is a perspective view of a spool-shaped hood included in a third embodiment of a lamp and hood assembly in accordance with the invention;

FIG. 8 is a cut away view of the hood shown in FIG. 7;

FIG. 9 is a perspective view of a fourth embodiment in which the hood has an abstract helical formation and it is fitted on the envelope of a compact fluorescent tube lamp;

FIG. 10 is a cut away view of the lamp and hood assembly shown in FIG. 9;

FIG. 11 is a perspective view of a cube-shaped hood included in a fifth embodiment of an assembly in accordance with the invention;

FIG. 12 shows one side of the cube-shaped hood illustrated in FIG. 11 that is sculpted to resemble an American flag;

FIG. 13 is a perspective view of the hood included in a sixth embodiment of the assembly in which the hood is in a multiple-star formation;

FIG. 14 is a perspective view of a seventh embodiment of an assembly whose lamp which is of the compact fluorescent tube type in which the envelope is formed by a cluster of hoops, the hood fitted on this envelope including a plug that projects into the cluster to stabilize the assembly;

FIG. 15 shows the underside of the hood illustrated in FIG. 14 in which the stabilizer plug is exposed; and

FIG. 16 shows an eight embodiment of an assembly whose sculpted hood is in the figurative form of a bird.

### DETAILED DESCRIPTION OF TE INVENTION

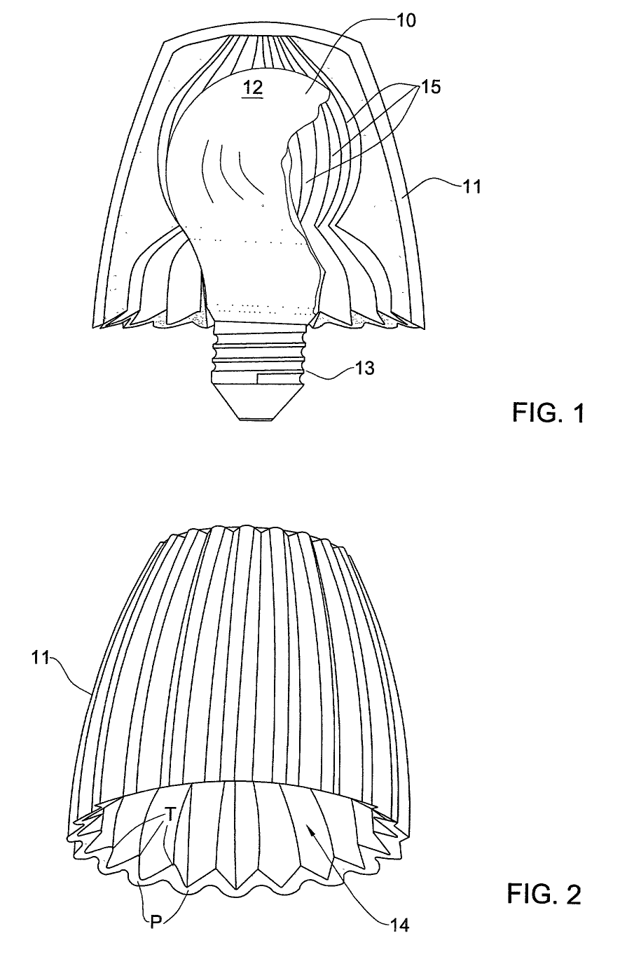

First Embodiment: Referring now to FIGS. 1 and 2 shown therein in a lamp and hood assembly in accordance with a preferred embodiment of the invention which consists of a standard incandescent light bulb 10 and a hood 11 fitted onto the bulb. Lamp 10 includes an evacuated bulbous glass envelope 12 within which is supported a filament. Envelope 12 is anchored on an externally-threaded cylindrical base 13 which screws into an internally-threaded socket (not shown) which supplies power to energize the electric lamp.

Hood 11 in the configuration shown in FIG. 1 is an abstract form of sculpture having a frusto-conical form whose outer surface is fluted. Hood 11 is formed of a translucent, elastomeric material such as a silicone polymer, the hood being molded in a mold which imparts the desired artistic shape thereto. In artistic terms, the elastomeric hood which fits onto a utilitarian lamp transforms its appearance without however masking its light.

Hood 11 is provided with an internal cavity 14 to accommodate the envelope 12 of the bulb 10 so tat the bulb is nested in the hood and concealed thereby. In order to provide air spaces between the envelope of the bulb and the bank of the cavity to permit the release of heat from the bulb, the interior of the cavity is provided with an array of longitudinally-extending fins 15 which project inwardly from the bank of the cavity and are integral therewith. The spaces between these fins define air flow channels.

These elastomeric is are contoured to engage the surface of the bulb envelope 12 and to clamp the envelope to the hood so as to hold the lamp in place. The air spaces between adjacent fins in the cavity act to vent heat from the bulb which is subject to failure should its heat become excessive. In practice the top of the hood may be provided with vent holes to permit the heated air to escape into the atmosphere.

In operation, when lamp 10 is screwed into a power socket which supplies power to energize the lamp so that it radiates light rays, these rays act to internally illuminate the translucent hood 11 to transform it into a work of light sculpture. The rays which pass through the translucent hood are diffused thereby so as to illuminate the region external to the assembly with “soft” rays. Hence, individuals who occupy this region will not have their eyes subjected to harsh and irritating light rays.

The sculptured hood is designed or sculpted by an artist and may assume an abstract non-representational form, such as that shown in FIG. 1 by way of example only. Or it may assume a figurative or representational form such as that of a human or minimal head. But in either case, light sculpture is created which functions as a source of “soft” illumination. The polymer forming the hood may be pigmented or dyed so that the translucent hood, when internally illuminated, has an orange, a blue or whatever other color is imparted to the hood. Thus what one sees when the lamp is turned on is not a physical body of sculpture but an incorporeal body of light. In practice, the hood may be injection or otherwise molded to impart the desired sculptured configuration to the hood.

The pattern of light created by fluted hood 11 corresponds to the physical form of the hood. This form of light sculpture is defined by variations in intensity of light emanating from the pattern.

The intensity of light emanating from any point in the illuminated hood depends on the light conductivity of the hood material and its thickness which together determine the degree to which light energy is lost when passing through the material. The thicker the material, the greater is the loss of light energy.

As shown in FIG. 2, the fluting in the hood gives rise to alternate thick and thin regions. As will be seen at the mouth of the hood cavity, the fluting creates a continuous wave of material each cycle of which has a peak P that is relatively thick which becomes progressively thinner as one goes from peak P to the trough T in which the material is relatively thin.

The intensity of light passing through the hood varies as a function of its thickness. As a consequence, the luminous pattern of light created by the internally illuminated hood is fluted, the flutes being defined by light of varying intensity.

When the lamp and hood assembly is to serve as a reading light or for other uses dictating a high level of illumination, then the translucent hood should be molded of clear plastic to minimize the loss of light. And the bulb should have the highest wattage that can be tolerated by the hood.

But if the assembly is intended to be primarily decorative and to provide a low level of light as when placed on a fashionable restaurant table then the hood may be molded of a colored plastic material to produce a relatively dim colored light.

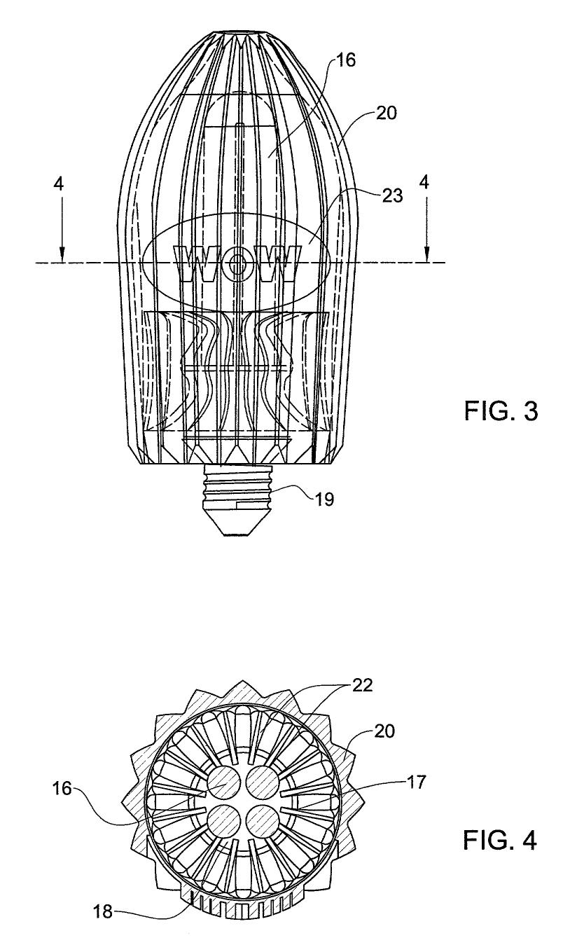

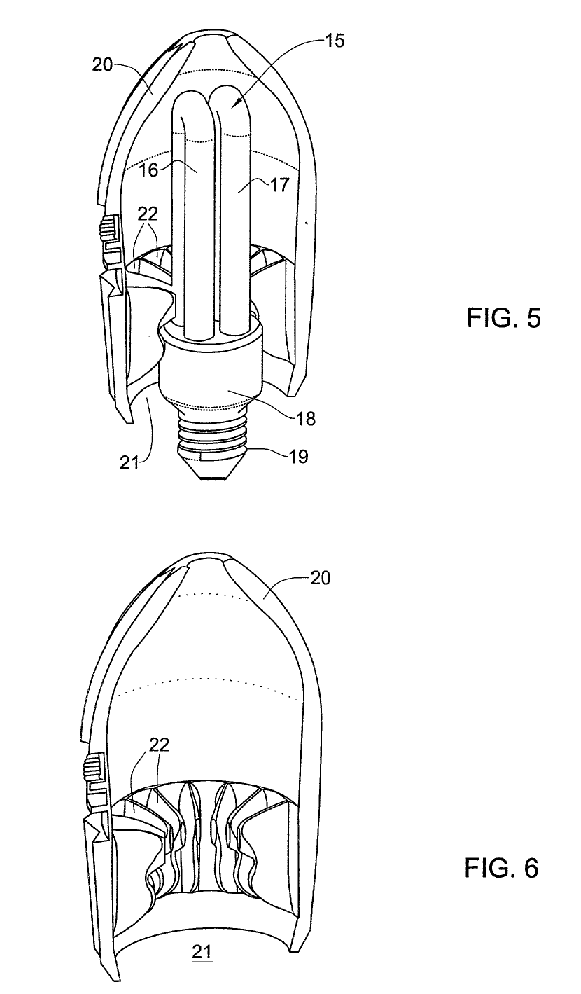

Second Embodiment: In this embodiment as shown in FIGS. 3, 4, 5 and 6 of a lamp and hood assembly, the lamp is of the screw-in fluorescent tube type. The envelope 15 of this lamp is in the form of an elongated fluorescent tube sinuously curved to define a cluster of two hoops 16 and 17 anchored on a cylindrical base 18 from which a threaded plug 19 projects. Plug 19 is screwable into a power socket which supplies power to the lamp.

The advantage of a fluorescent tube over an incandescent bulb lamp is that for a given wattage rating, it provides a much greater light output than an incandescent light bulb having the same rating. However, light from a fluorescent tube is harsher than light from an incandescent light bulb; hence the diffusing character of the hood is of great value in this context.

The translucent hood 20 of elastomeric material fits over the envelope of is fluorescent lamp 15 formed by the cluster of hoops. The hood is provided adjacent the inlet to its cavity 21 with a circular array of inwardly projecting fins 22 which are integral with the wall or bank of de cavity and engage the surface of base 18 of the lamp. Because fins 22 are elastomeric, they are compressed by base 18 of the lamp and therefore act to clamp the lamp in place within the hood.

Hood 20, as shown in FIG. 3, is molded to assume a bullet-like shape whose surface is corrugated to form a cage of curved ribs.

Hood 20 is embossed to present in an oval plaque 23 the letters of a word which in this instance, by way of example, is the word WOW. This word, in effect, labels the hood and may be used for promotional purposes such as by applying the words Coca Cola to the hood.

Because the letters of the word on the hood have a greater material thickness than the plaque 23 from which the letters project, less light emanates from the letters than from the plaque and the resultant contrast causes the letters to be prominent.

And instead of the letters of a word, one can apply on the plaque a symbol or logo.

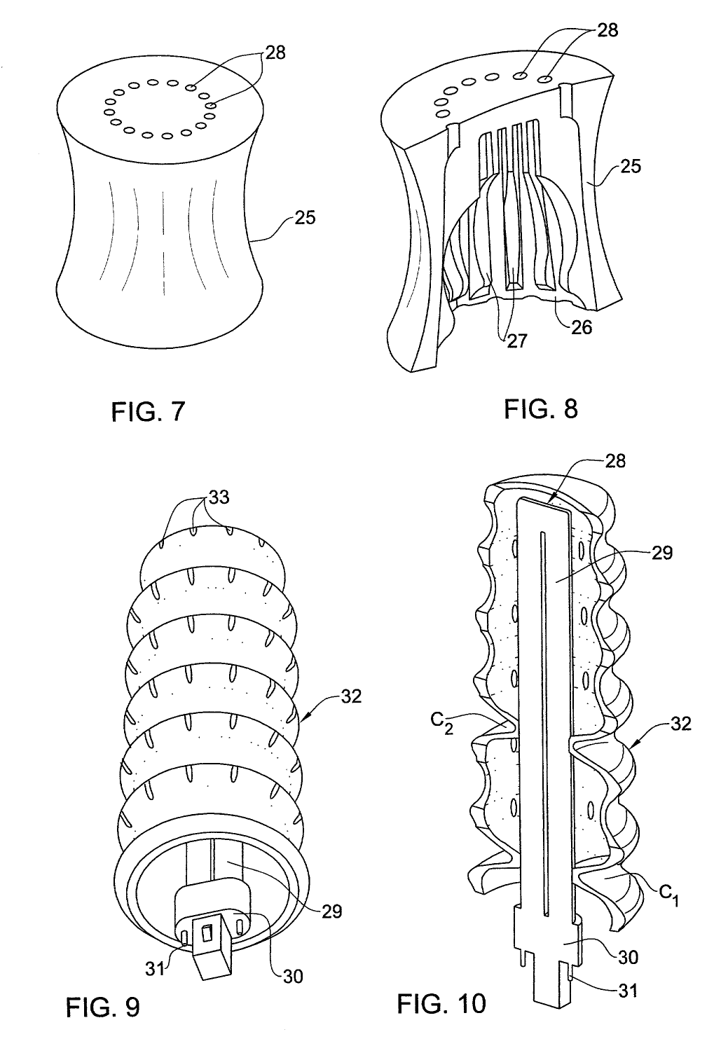

Third Embodiment: In this embodiment which is illustrated in FIGS. 7 and 8, the hood 25 formed of translucent, elastomeric material is provided with a cavity 26 having an array of fins or ribs 27 adapted to engage the envelope of an incandescent light bulb, (not shown) of relatively high wattage, hence a bulb which runs very hot.

The hood which in this embodiment has a spool-like shape is capable of being fitted onto a high-wattage bulb, such as one having a rating of 75 watts and higher even though the hood acts as a thermal blanket which slows down the escape of heat from the bulb. Such escape is necessary to prevent overheating of the bulb.

To cool the bulb, hood 25 is made to function as a chimney by means of a ring of venting apertures in the top wall of the hood. The chimney is created by an inlet to the cavity 26 which conducts air through the channels between the fins 27 in the cavity to the vent holes 28 at the flat top of the hood. The air within the channels which is heated by the bulb is well above ambient temperature, whereas the air outside the hood is at ambient temperature. This results in a pressure differential, giving rise to the forced flow of air through the chimney from which it is discharged into the atmosphere, thereby dissipating the heat.

Fourth Embodiment: As illustrated in FIGS. 9 and 10, this embodiment of an assembly includes a compact fluorescent lamp 28 provided with a single hoop 29 anchored on a base 30 having plug-in contacts 31.

Fitted over hoop 29 of the lamp is an elongated hood 32 molded of translucent elastomeric material to create an abstract helical form whose convolutions increase progressively in diameter from the upper to the lower end of the hood. The lowermost convolution C1 and an intermediate convolution C2 of the hood project inwardly as shown in FIG. 10 to engage and clamp the hoop 29 of the lamp to hold the hood in place.

Each convolution of the helix is provided with a series of notches 33. As a consequence, the material of the hood behind the notches is thinner than the material flanking the notches. When therefore the hood is internally illuminated, the notches are brighter than the convolution and stand out.

Again it must be noted that the illuminated hood is a work of illuminating light sculpture whose incorporeal three-dimensional body of light is an artistic creation.

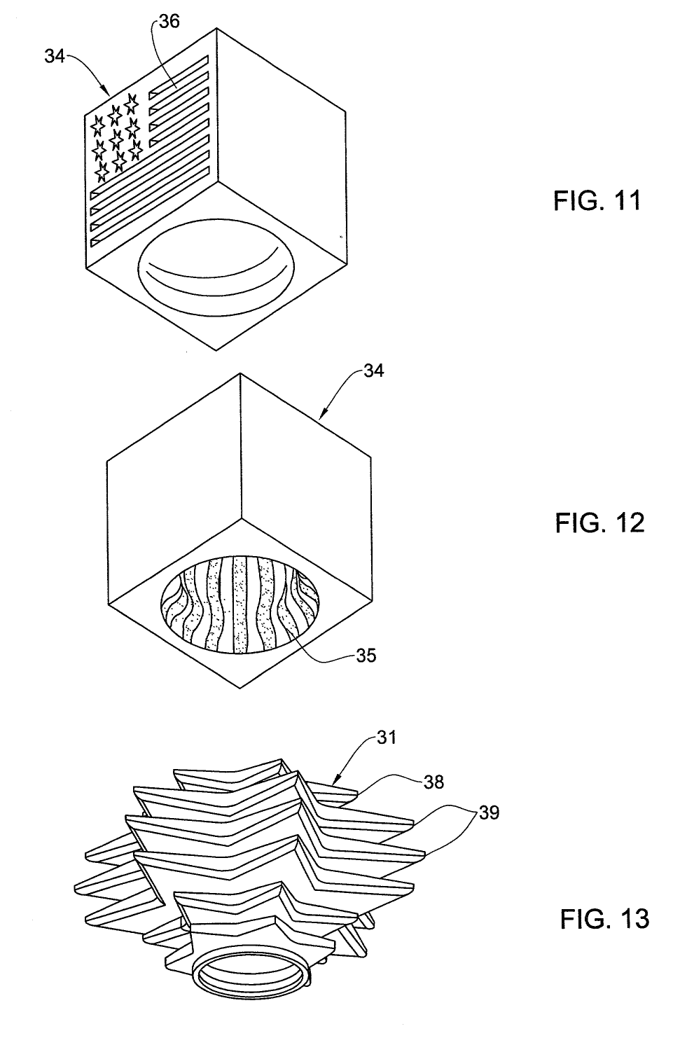

Fifth Embodiment: As illustrated in FIGS. 11 and 12, the hood 34 of this lamp and hood assembly has the form of a cube provided with a cavity having a circular array of inwardly projecting fins or ribs 35. These elastomeric fins are contoured to engage and clamp onto the bulb of an incandescent lamp.

Indented in one square side wall 36 of the cubical hood 34 are parallel stripes and a group of stars which together resemble the flag of the United States.

When hood 34 is internally illuminated, the indentations which define the US flag are then somewhat brighter than the rest of the side wall and the geometry of the flag is then defined in terms of different light intensities.

An alternative form of a cube-shaped hood is an outwardly pure cube within whose cavity are longitudinally extending fins which act to striate the light radiating from the cube.

Sixth Embodiment: In this embodiment, the elastomeric hood 37 of the lamp and hood assembly is composed of a stack of star-like layers 38, each layer having a circular series of pointed projections 39. The length of these projections differ from layer to layer to create a complex form of abstract sculpture.

Because of differences in the thickness of the hood material created by the projections and the resultant differences in the intensity of light radiating from the hood, when the hood is internally illuminated. It creates a light sculpture in which the pointed projections stand out.

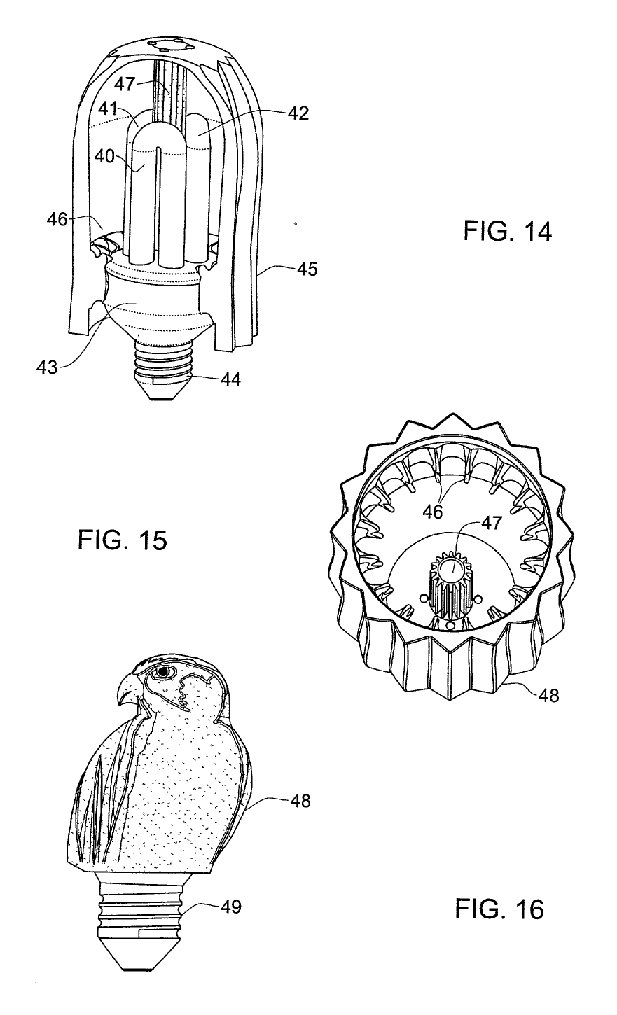

Seventh Embodiment: As shown in FIGS. 14 and 15 in the embodiment of a lamp and hood assembly the concentrated envelope of a compact fluorescent lamp is composed on a round cluster of Free hoops 40, 41 and 42 which encircle a central free space. The hoops are anchored on a base 43 from a screw plug 44 projecting therefrom.

Elastomeric hood, 45 which fits over the envelope of this lamp is provided with a circular array of inwardly projecting fins which engage and clamp onto base 43 of the lamp.

In order to maintain the hood so that it is symmetrically disposed with respect to the lamp, hood 45 is provided with an elastomeric plug 47 tat projects downwardly from the center of the top wall of the hood.

When hood 45 is installed on the lamp, the plug of the hood is pushed into the free space in the cluster of hoops and engage the hoops and thereby stabilize the position of the hood.

Eighth Embodiment: In the preceding embodiments, each hood included in the assembly constitutes an abstract or non-representation form of sculpture whose actual form is only limited by the ability to mold a hood having a desired configuration.

But in practice, the sculpture of the hood may be figurative or representational in form. An example of this hood is shown in FIG. 16 in which hood 48 in whose cavity a screw type light bulb 49 is nested, has the form of a beaked bird. In practice the hood may be a replica of a human bead, such as that of a famous rock star who is an icon figure. Thus fans devoted to this star can be supplied with a hood which is a replica of the icon's head. The internal illumination of this three-dimensional head would provide the fan with greater satisfaction than a blow-up, two-dimensional picture of the rock star.

While there has been shown preferred embodiments of a lamp and hood assembly in accordance with the invention, it is to be understood that many changes may be made therein without departing from the spirit of the invention.

1. A lamp and hood assembly forming an illuminating light sculpture comprising:
A. a hood molded of translucent, elastomeric material shaped to define a work of sculpture having a cavity therein to accommodate a lamp; and
B. an electric lamp having an envelope anchored on a base connectable to a power source to energize the lamp, said lamp being nested in said cavity whereby when the lamp is energized, it internally illuminates the sculpture, the translucent hood acting to diffuse rays passing therethrough to illuminate an external region with soft rays.

2. An assembly as set forth in claim 1, in which the lamp is an incandescent light bulb whose base is a plug that is treadably received in a socket which supplies power to the bulb.

3. An assembly as set forth in claim 1, in which the lamp is a compact fluorescent tube lamp in which the tube is sinuously curved to form a cluster of hoops forming the envelope of the lamp.

4. An assembly as set forth in claim 1, in which the material is a silicone polymer.

5. An assembly as set forth in claim 1, in which the material is a polymer that is dyed to impart a distinctive color to the sculpture and to light radiated therefrom.

6. An assembly as set forth in claim 1, in which projecting inwardly from the cavity and integral therewith is a circular array of fins which engage the lamp nested therein and clamp the lamp in place.

7. An assembly as set forth in claim 6, in which the lamp has an envelope anchored on a cylindrical base, and the fins engage the envelope.

8. An assembly as set forth in claim 6, in which the hood has vent holes at its top to form a chimney in which air drawn into the hood through the cavity passes through air spaces between adjacent fins to be discharged from the vent holes.

9. An assembly as set forth in claim 1, in which the sculpture has an abstract, non-representational configuration.

10. A assembly as set forth in claim 9, in which the form is tint of a stack of star-shaped layers.

11. An assembly as set forth in claim 9, in which the form is that of a cube within whose cavity are longitudinally extending fins which act to striate light emanating from the cube.

12. An assembly as set forth in claim 9, in which the hood is shaped like a drum.

13. An assembly as set forth in claim 1, in which the sculpture has a figurative spool.

14. An assembly as set forth in claim 13, in which the form is that of a bird.

15. An assembly as set forth in claim 13, in which the form is a replica of a human head.

16. An assembly as set forth in claim 1, in which the letters of a word are embossed on the hood material whereby the thickness of the letters is greater than that of the material adjacent the letters, giving rise to corresponding differences in the intensity of light radiated from the hood to cause the letters to stand out.

17. An assembly as set fort in claim 2, in which the cluster of hoops in the lamp surround a central space, and said hood is provided with a plug that projects from its loop and enters the space to stabilize the position of the hood.
